(19) United States
(12) Patent Application Publication
(10) Pub. No.: US 2009/0155601 A1
(43) Pub. Date: Jun. 18, 2009

(54) ULTRAVIOLET PROTECTIVE MATERIAL

(76) Inventors: Adalbert E. Lavature, Huntington, MA (US); Duarte Pimentel, Acushnet, MA (US)

Correspondence Address: MALDJIAN & FALLON LLC, 365 BROAD ST. , 3RD FLOOR, RED BANK, NJ, 07701, US

(21) Appl. No.: 11/954,258

(22) Filed: Dec. 12, 2007

(51) Int. Cl. B32B 27/40; C09J 4/00

(52) U.S. Cl. 428/424.2; 156/280; 156/327

(57) ABSTRACT

Embodiments of the present invention generally relate to an ultraviolet protective material incorporating a polyurethane film, and optionally having an ultraviolet protective adhesive layer applied to one side. In one embodiment, an ultraviolet protective material comprises an aliphatic polyurethane film, and an adhesive layer comprising a formulated acrylic pressure-sensitive and an ultraviolet light stabilizer. Alternative embodiments of the present invention provide the ultraviolet protective material may be embodied in various forms, including: single and multi-layer films, adhesive tapes, and resins.

### BACKGROUND OF THE INVENTION

1. Field of the Invention

Embodiments of the present invention generally relate to an ultraviolet protective material. More specifically, embodiments of the present invention relate to an ultraviolet protective material incorporating a polyurethane film, and optionally having an ultraviolet protective adhesive layer applied to one side.

2. Description of the Related Art

Exposure to ultraviolet radiation is known to cause extensive damage to many materials. Aside from being linked to skin cancer and other human diseases, ultraviolet radiation has been known to cause degradation of materials of construction due to prolonged exposure. It is desirable, therefore, to protect ourselves and our possessions from the effects of this natural radiation.

Ultraviolet-resistant products currently exist on the market. Many sprays, coatings, and other products exist which can be applied to various surfaces in order to block or absorb ultraviolet radiation. However, the ultraviolet-protective chemicals present in these applications typically absorb the ultraviolet radiation and, in doing so, alter the chemical structure of the protectant thus spending the chemical and spoiling its functionality. Consequently, ultraviolet-resistant materials in these applications do not last for a significant amount of time, and therefore, need to be constantly reapplied.

Thus, there is a need for a self-regenerating, long-lasting composition which protects surfaces against ultraviolet radiation.

### SUMMARY OF THE INVENTION

Embodiments of the present invention generally relate to an ultraviolet protective material incorporating a polyurethane film, and optionally having an ultraviolet protective adhesive layer applied to one side.

In one embodiment, an ultraviolet protective material comprises an aliphatic polyurethane film, and an adhesive layer comprising a formulated acrylic pressure-sensitive and an ultraviolet light stabilizer on one side. Optionally, the ultraviolet protective material further comprising a release liner disposed on the adhesive layer.

In another embodiment of the present invention, a method of protecting a surface comprises providing a surface and an ultraviolet protective material having at least an aliphatic polyurethane film and a formulated adhesive layer comprising an acrylic pressure-sensitive and an ultraviolet light stabilizer, applying a layer of an ultraviolet protective wax to the surface, and applying the protective material to the surface, covering the layer of ultraviolet protective wax.

In yet another embodiment, a method of manufacturing a protective material comprises providing an aliphatic polyurethane film, and applying an adhesive layer comprising a formulated acrylic pressure-sensitive and an ultraviolet light stabilizer to a first side of the aliphatic polyurethane film.

### BRIEF DESCRIPTION OF THE DRAWING

So the manner in which the above recited features of the present invention can be understood in detail, a more particular description of embodiments of the present invention, briefly summarized above, may be had by reference to embodiments, which are illustrated in the appended drawing. It is to be noted, however, the appended drawing illustrates only typical embodiments of embodiments encompassed within the scope of the present invention, and, therefore, is not to be considered limiting, for the present invention may admit to other equally effective embodiments, wherein:

FIG. 1 depicts a cross-sectional view of an ultraviolet protective material in accordance with one embodiment of the present invention;

FIG. 2 depicts a flowchart of a method for making an ultraviolet protective material in accordance with one embodiment of the present invention;

FIG. 3 depicts a flowchart of a method for protecting a surface utilizing an ultraviolet protective material in accordance with one embodiment of the present invention;

FIGS. 4 and 5 depict test results achieved during experimentation with several ultraviolet protective materials, in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to an ultraviolet protective material. More specifically, embodiments of the present invention relate to an ultraviolet protective material incorporating a polyurethane film, and optionally having an ultraviolet protective adhesive layer applied to one side.

FIG. 1 depicts a cross-sectional view of a protective material 100 in accordance with one embodiment of the present invention. In accordance with embodiments of the present invention, a protective material 100 generally comprises a polymer film 102 and a formulated adhesive layer 104 applied to one side of the polymer film 102. Optionally, in one embodiment of the present invention, a release liner 106 may be disposed on the adhesive layer 104 so that the material does not adhere to itself or to any other object during storage and/or transport.

In one embodiment of the present invention, the polymer film 102 comprises polyurethane. In another embodiment, the polymer film 102 comprises an aliphatic polyurethane. In several embodiments, the polymer film 102 comprises a polyurethane layer and a polyethylene terephthalate (PET) film layer (not shown). The polymer film 102 is generally provided in a thickness of between about 2 mils and about 20 mils. In another embodiment of the present invention, the polymer film 102 is provided in a thickness of about 5 to 7 mils.

Optionally the polymer film 102 may also comprise additional stabilizers and additives. For example, in one embodiment the polymer film 102 further comprises a light stabilizer. In one embodiment, the light stabilizer comprises an ultraviolet light absorbing agent, such as 3,5-di-t-Butyl-4-Hydroxybenzoic Acid, Hexadecyl Ester. In another embodiment, the light stabilizer comprises an ultraviolet light absorbing agent and free radical scavenger, commercially available from CYTEC Industries, Inc., with offices in West Paterson, N.J., under the name CYASORB® UV-2908. The light stabilizer may be provided in the film layer 102 in between about 0.50% and about 3.00% by weight. In one embodiment, the light stabilizer is provided in the film layer 102 in about 1.56% by weight.

In another embodiment, the polyurethane film layer 102 comprises a UV light stabilizer, commercially available from Ciba Specialty Chemicals Corp. of Tarrytown N.Y. under the name Tinuvin 765. The Tinuvin 765 may be provided in the film 102 in between about 0.10% and about 0.50% by weight.

The polymer film 102 generally has a tensile strength between about 35 pounds per inch width and 50 Pounds per inch width and an elongation of between about 380% and 450%. In one embodiment, the polymer film 102 has a tensile strength of about 30 Pounds per inch width and an elongation of about 364%. The polymer film 102 also has a puncture resistance between about 18 Pounds and about 30 Pounds. In one embodiment, the puncture resistance is about 28 Pounds ASTM-D-1000 .166″ needle.

Optionally, the polymer film 102 may comprise a protective wax coating on the top surface of the polymer film 102. In one embodiment, the polymer film 102 comprises a coating of clear polytetrafluoroethylene (PTFE)-based ultraviolet resistive wax. In one exemplary embodiment, the polymer film 102 comprises a coating of clear PTFE-based ultraviolet resistive wax, commercially available under the brand name Star Brite with Teflon. Optionally, a protective wax coating may be applied to the polymer film 102 after the protective material 100 has been formed.

The adhesive layer 104 generally comprises a formulated pressure-sensitive adhesive (PSA). In many embodiments, the adhesive layer comprises an acrylic or acrylic-based pressure sensitive adhesive. In one embodiment, the adhesive layer comprises an acrylic pressure-sensitive adhesive, commercially available from Rohm & Hass Company, with offices in Philadelphia, Pa., under the name MORSTIK™ 717. In many embodiments, the adhesive layer 104 is generally applied on the polymer film 102 between about 1.3 mils to about 1.7 mils thick. In one embodiment, the adhesive layer 104 is applied on the polymer film 102 about 1.5 mils thick. The UV properties are uniquely formulated into the acrylic adhesive system.

The adhesive layer 104 additionally comprises at least one or more additives. In one embodiment, the adhesive layer 104 comprises a light stabilizer. In one embodiment, the light stabilizer comprises an ultraviolet light absorbing agent, such as 3,5-di-t-Butyl-4-Hydroxybenzoic Acid, Hexadecyl Ester, and a solvent. In another embodiment, the light stabilizer comprises an ultraviolet light absorbing agent and free radical scavenger, commercially available under the name CYASORB® UV-2908. The light stabilizer may be provided in the adhesive layer 104 in between about 0.50% and about 3.00% by weight. In one embodiment, the light stabilizer is provided in the adhesive layer 104 in about 1.56% by weight.

In one embodiment, the adhesive layer 104 comprises a UV light stabilizer, commercially available under the name Tinuvin 765. The Tinuvin 765 may be provided in the adhesive layer 104 in between about 0.10% and about 0.50% by weight.

In another embodiment of the present invention, the adhesive layer 104 comprises a catalyst. In one embodiment, the catalyst is provided to expedite a higher crosslink density of the formulated adhesive.

As contemplated by embodiments of the present invention, the catalyst may comprise a catalytic compound and a solvent. One catalytic compound suitable for embodiments of the present invention is commercially available from MacKenzie Company LLC, with offices in Bush, La. Other embodiments provide a catalyst comprising at least one of aluminum trisacetylacetonate, aluminum, tris(acetylacetonate), tris(acetylacetonate) aluminum, aluminum tris(pentanedionato), tris(acetylacetonate) aluminum, tris(acetylacetonate) aluminum, tris(pentanedionato) aluminum, tris(pentanedionato) aluminum, or tris(pentanedionato) aluminum. The catalyst may be provided in the adhesive layer 104 in between about 0.50% and about 2.50% by weight. In one embodiment, the catalyst is provided in the adhesive layer 104 in about 0.86% by weight.

The optional release liner 106 may be disposed on the adhesive layer 104 opposite the polymer film 102. The release liner 106 may be applied to the adhesive layer 104 using a coating process, such as, lamination to the coating, a lamination process, such as, adhesive coating and lamination, or other standard application processes. The release liner 106 may comprise a silicone liner material, or non-silicone release liner material, such as polyvinyl octadecylcarbamate. In one embodiment, the release liner 106 comprises a layer of an adhesion-resistant substance, such as paraffin wax, for easy removal. In another embodiment, the release liner 106 comprises a paper, film or foil coated with an adhesion-resistant substance, such as silicone.

Alternative embodiments of the present invention provide the ultraviolet protective material may be embodied in various forms, including: single and multi-layer films, adhesive tapes, and resins. Such various forms of embodiments of the present invention may be manufactured by any means, without deviating from the novel and unique compositions, formulations and concepts disclosed herein.

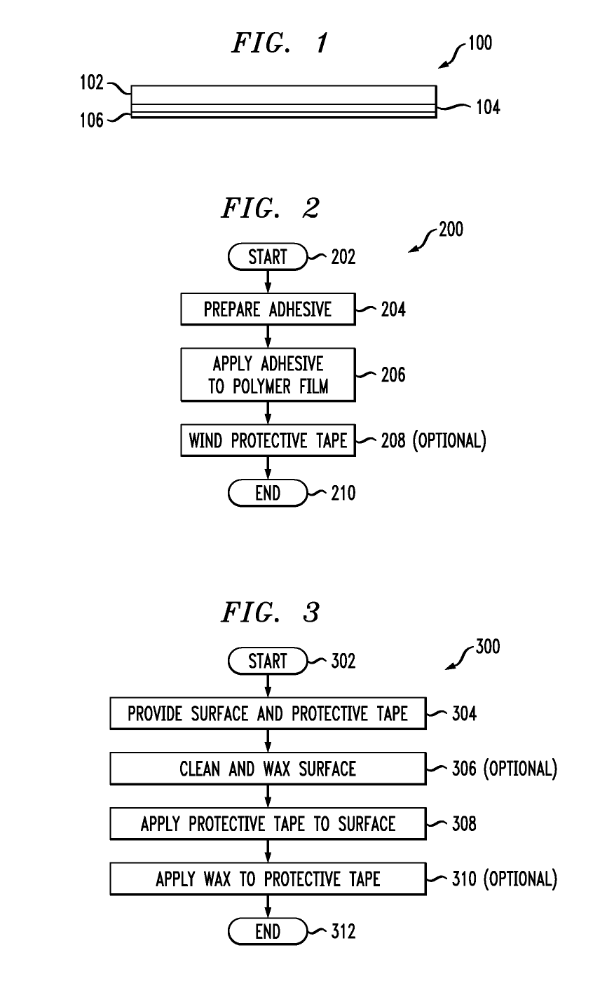

FIG. 2 depicts a flowchart of a method for making a protective material 100 in accordance with one embodiment of the present invention. The method 200 begins at step 202. At step 204, an adhesive is prepared. In one embodiment, the adhesive is compounded in a mixer inserted into a fifty-five gallon drum of the adhesive compound to be mixed by a high torque mixer. Other ingredients are added to the blend as specified in the formulation, including any light stabilizers, tackifiers, catalysts, or the like. The final mixture is thick but smooth enough to be pumped to the coating equipment.

At step 206, the adhesive and the polymer film 102 are combined using sophisticated coating equipment. In one embodiment, the solvent based adhesive is metered between rollers with a precise fixed gap. A roller typically consists of closely spaced hollow rollers made of heavy gauge stainless steel. The rollers are attached to high torque gears and a motor, and may or may not be rotated at a predetermined speed. The adhesive is fed into this space, or gap which in turn, meters the liquid adhesive on to the substrate. This arrangement allows the liquid adhesive to form a thin sheet across the surface of the substrate. The coated substrate then passes into a multiple zone oven where the solvents are evaporated and the adhesive is crosslinked. In one embodiment the zone temperatures may be ninety degrees F., one hundred-fifty degrees F. and two hundred-fifty degrees F.

In another embodiment the oven zone temperatures may be one hundred degrees F., one hundred twenty-five degrees F. and two hundred degrees F. the coating line speed could range between fifteen feet per minute to sixty feet per minute. In another embodiment the line speed was forty feet per minute. Before the final wind the release liner is laminated to the adhesive.

In one embodiment, the polymer is metered between coating roll and wiped onto the substrate before going into the oven. In another embodiment the adhesive is metered on to the substrate using a wire wound rod. In still another embodiment the adhesive is sprayed or rolled onto the web and metered through fixed rolls or knives.

Optionally, a release liner 106 may be laminated onto the adhesive layer 104 using a conventional coating process. At step 208, the polymer film 102 and adhesive layer 104, collectively forming a protective material 100, are then wound onto large cores. When a sufficient length of protective material 100 is on a core, it is removed and cut to the proper size. The method 200 ends at step 210, resulting in a protective material 100 as described in connection with FIG. 1 above.

FIG. 3 depicts a flowchart of a method for protecting a surface utilizing a protective material 100 in accordance with one embodiment of the present invention. Method 300 begins at step 302. At step 304, a surface requiring ultraviolet protection (e.g., the brightwork or wood on a boat deck) and the protective material 100 as shown in FIG. 1 are provided.

At step 306, the surface is cleaned and an optional layer of ultraviolet protective wax is applied to the surface. In one embodiment, the ultraviolet protective wax comprises a clear PTFE-based ultraviolet resistive wax. In one exemplary embodiment, the ultraviolet protective wax comprises a clear PTFE-based ultraviolet resistive wax, commercially available under the brand name Star Brite with Teflon.

At step 308, the protective material 100 is applied to the surface. In one embodiment, the protective material 100 is unwound from a roll and a release liner 106 is removed from the protective material 100 before being applied to the surface. In another embodiment, the protective material 100 is applied to the surface in a manner preventing air bubbles or wrinkles from forming between the adhesive layer 104 and the surface.

At step 310, an optional layer of ultraviolet protective wax may be applied to the top side of the protective material 100. The ultraviolet protective wax may be a clear PTFE-based ultraviolet resistive wax, such as the wax described above. The method 300 ends at step 312, resulting in a surface having superior ultraviolet resistive properties.

The resulting material is substantially colorless and transparent, and possesses highly desirable self-regenerative and ultraviolet protective characteristics. In many embodiments, the material has an ultraviolet transparency at about 500 nm, between about 92.0% and about 98.0%. In one embodiment, the material has an ultraviolet transparency at about 500 nm, between about 93.0% and about 95.0%. In other embodiments, the material has a maximum ultraviolet transparency between about 0.0% to about 5.0% at a range between about 280 nm and about 340 nm. In one embodiment, the material has a maximum ultraviolet transparency between about 0.1% to about 3.0% at a range between about 280 nm and about 340 nm.

### Experimental Testing

UV/Visible Light Transmission Test

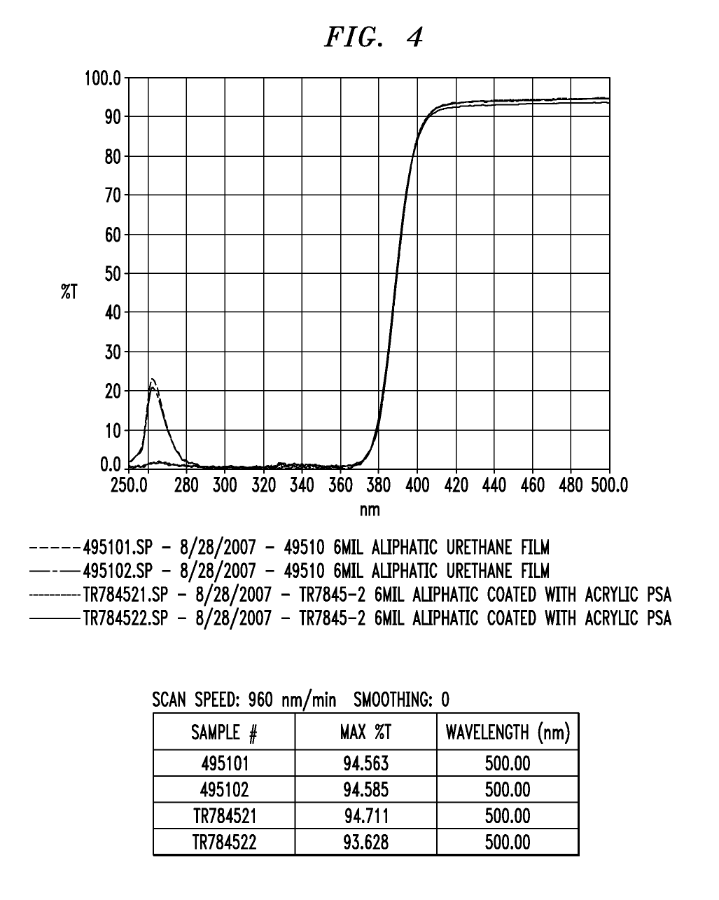

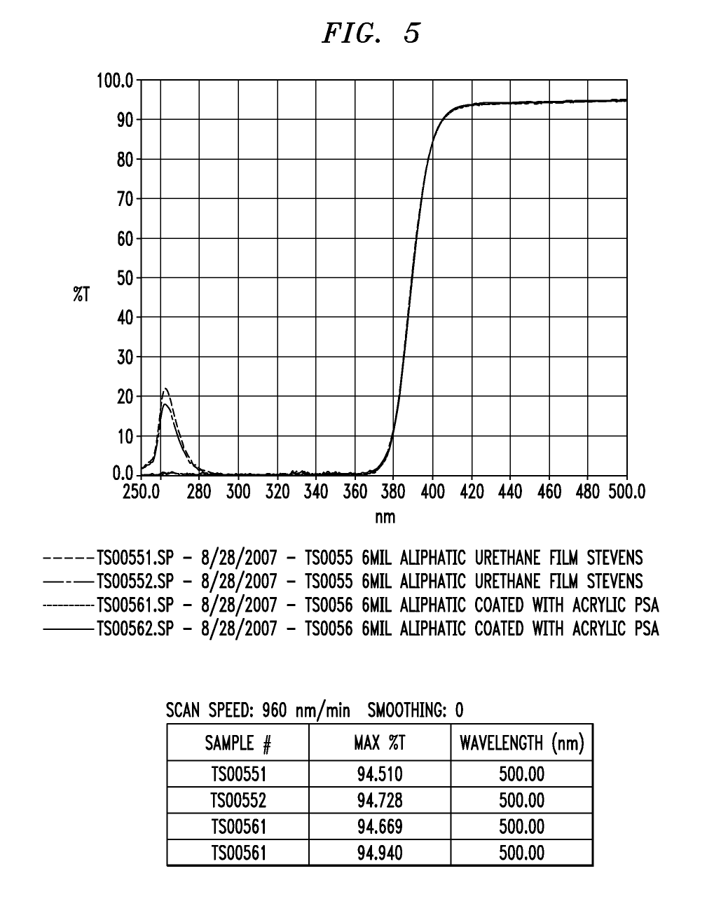

FIGS. 4 and 5 depict test results achieved during experimentation with several ultraviolet protective materials, in accordance with embodiments of the present invention. The tests were performed utilizing a Lambda 40 Spectrophotometer, commercially available from PerkinElmer, a company with a headquarters in Waltham, Mass. The tests were administered by Kerr Group Inc., a Berry Plastics Corporation subsidiary, with offices in Lancaster, Pa. The tests were generally conducted in accordance with testing parameters set forth by the control manual for the Lambda 40 Spectrophotometer, and by ATSM D-1003, which provides the standardized testing parameters for “Haze and Luminous Transmittance of Transparent Plastics.”

The results of the testing showed desirable characteristics of embodiments of the present invention (“specimen”). Each of the specimen tested allowed substantially all of the visible electromagnetic rays tested to pass through the material (i.e., frequencies greater than about 400 nm), while a majority harmful ultraviolet electromagnetic rays were substantially blocked (i.e, frequencies between about 280 nm and 340 nm). More specifically, across the eight specimen tested, approximately 93.628% to approximately 94.940% of the desired visible light rays were permitted to pass through the material. In the same specimen, only about 0.1% to about 3.0% of the harmful ultraviolet light rays were permitted to pass through the material. FIGS. 4 and 5 depict the detailed performance curves of the various embodiments tested during this experimentation.

As exemplified in the Figures, embodiments of the present invention portray highly advantageous ultraviolet protection while remaining substantially transparent in the visible light spectrum.

Weathering Test

A second experimental test was performed on embodiments of the present invention to determine whether the embodiments of the present invention were suitable for one of the intended uses of the ultraviolet protective material, i.e., whether the ultraviolet protective material could protect a wood panel when exposed to the equivalent of the weather conditions of the southeastern United States.

The tests were conducted in accordance with ASTM G155 (previously ASTM G26A). Wood panels were covered on one-half with different embodiments of the present invention and were exposed to testing conditions for approximately thirty days. The other half of the wood panels were left unfinished for comparison. The testing conditions comprised exposure to an irradiance of about 340 nm at 0.35 w/m²; a black panel temperature of about 63 degrees Celsius; a chamber temperature of about 42 degrees Celsius; and a relative humidity of about 50%. The resulting exposure of the testing was equivalent to six months of “Florida weather.”

After the thirty day testing period, the portion of the wood panels protected by an embodiment of the present invention were substantially unchanged, while the unfinished portion showed signs of deterioration and environmental fatigue.

The testing for each of the wood panels was continued for an additional 150 days to achieve an equivalent environment exposure of approximately three years. After this testing period, the portion of the wood panels protected by an embodiment of the present invention was substantially unscathed by the environmental conditions and completely intact, while the unprotected portion was severely damaged and worn.

The results of this testing evidenced the presumption that the characteristics of the novel compositions of embodiments of the present invention improve with exposure to ultraviolet light and environmental conditions. Such unique results were previously unattainable in the industry.

While the foregoing is directed to embodiments of the present invention, other and further embodiments of the invention may be devised without departing from the basic scope thereof.

What is claimed is:

1. A ultraviolet protective material comprising:
a transparent aliphatic polyurethane film; and
an adhesive layer comprising an acrylic pressure-sensitive and an ultraviolet light stabilizer.

2. The ultraviolet protective material of claim 1 further comprising a release liner disposed on the adhesive layer.

3. The ultraviolet protective material of claim 1, wherein the aliphatic polyurethane film has a thickness between about 2 mils and about 20 mils.

4. The ultraviolet protective material of claim 3, wherein the aliphatic polyurethane film has a thickness of about 6 mils.

5. The ultraviolet protective material of claim 1 further comprising a layer of transparent polytetrafluoroethylene-based ultraviolet resistive wax disposed on a top surface of the aliphatic polyurethane film.

6. The ultraviolet protective material of claim 1, wherein the ultraviolet light stabilizer comprises an ultraviolet light absorbing agent and a solvent.

7. The ultraviolet protective material of claim 6, wherein the ultraviolet light absorbing agent comprises 3,5-di-t-Butyl-4-Hydroxybenzoic Acid, Hexadecyl Ester.

8. The ultraviolet protective material of claim 1 wherein the adhesive layer comprises: between about 94.00% to about 99.40% by weight acrylic-based pressure sensitive adhesive;
between about 1.00% to about 3.00% by weight ultraviolet light absorbing agent;
between about 0.10% to about 0.30% by weight UV light stabilizer; and
between about 0.50% to about 1.50% by weight catalyst.

9. The ultraviolet protective material of claim 8 wherein the ultraviolet light absorbing agent comprises 3,5-di-t-Butyl-4-Hydroxybenzoic Acid, Hexadecyl Ester.

10. The ultraviolet protective material of claim 8 wherein the adhesive layer comprises:
about 97.40% by weight acrylic-based pressure sensitive adhesive;
about 1.56% by weight ultraviolet light absorbing agent;
about 0.19% by weight UV light stabilizer; and
about 0.86% by weight catalyst.

11. The ultraviolet protective material of claim 10 wherein the ultraviolet light absorbing agent comprises 3,5-di-t-Butyl-4-Hydroxybenzoic Acid, Hexadecyl Ester.

12. The ultraviolet protective material of claim 1, wherein the ultraviolet protective material has a transparency at about 500 nm of between about 93.0% and 95.0% and a maximum transparency of about 3.0% between about 280 nm and about 340 nm.

13. A method of protecting a surface comprising the steps:
providing a surface and a protective tape having at least an aliphatic polyurethane film and an adhesive layer comprising an acrylic pressure-sensitive and an ultraviolet light stabilizer;
applying a layer of an ultraviolet protective wax to the surface; and applying the protective tape to the surface, covering the layer of ultraviolet protective wax.

14. The method of protecting a surface according to claim 13, further comprising:
applying a layer of an ultraviolet protective wax to a top surface of the protective tape.

15. The method of protecting a surface according to claim 13, wherein the ultraviolet light stabilizer comprises 3,5-di-t-Butyl-4-Hydroxybenzoic Acid, Hexadecyl Ester.

16. The method of protecting a surface according to claim 13, wherein the adhesive layer comprises:
between about 94.00% to about 99.40% by weight acrylic-based pressure sensitive adhesive;
between about 1.00% to about 3.00% by weight ultraviolet light absorbing agent;
between about 0.10% to about 0.30% by weight UV light stabilizer; and
between about 0.50% to about 1.50% by weight catalyst.

17. The method of protecting a surface according to claim 12, wherein the adhesive layer comprises:
about 97.40% by weight acrylic-based pressure sensitive adhesive;
about 1.56% by weight ultraviolet light absorbing agent;
about 0.19% by weight UV light stabilizer; and
about 0.86% by weight catalyst.

18. A method of manufacturing a protective material comprising the steps:
providing a aliphatic polyurethane film; and
applying an adhesive layer comprising an acrylic pressure-sensitive and an ultraviolet light stabilizer to a first side of the aliphatic polyurethane film.

19. The method of manufacturing a protective material according to claim 18, further comprising:
applying a release liner to the adhesive layer.

20. The method of manufacturing a protective stabilizer according to claim 18, wherein the ultraviolet light stabilizer comprises 3,5-di-t-Butyl-4-Hydroxybenzoic Acid, Hexadecyl Ester.
